(19) United States
(12) Patent Application Publication
(10) Pub. No.: US 2015/0082206 A1
(43) Pub. Date: Mar. 19, 2015

(54) METHODS AND APPARATUS TO DETECT POP-UP/POP-UNDER WINDOWS IN A BROWSER

(71) Applicant: Bin Lay Low, Saratoga, CA (US)

(72) Inventor: Bin Lay Low, Saratoga, CA (US)

(21) Appl. No.: 14/031,944

(22) Filed: Sep. 19, 2013

(51) Int. Cl. G06F 3/0481

(52) U.S. Cl. CPC G06F 3/0481
USPC 715/760

(57) ABSTRACT

Methods and apparatus to identify pop-up/pop-under windows in a browser are disclosed. An example method includes identifying web page load events corresponding to a user action on a monitored device, identifying at least one of a life span or a page load history of a first browser window, and determining that the first browser window is secondary browser window based on at least one of the life span or the page load history.

### FIELD OF THE DISCLOSURE

This disclosure relates generally to online measurement, and, more particularly, to methods and apparatus to detect pop-up/pop-under windows in a browser.

### BACKGROUND

Companies that advertise their products or services on the Internet have an interest in determining how users are exposed to (e.g., consume) their advertisements. Internet monitoring can be achieved in a number of ways. For example, monitoring can be performed at the client-side to monitor user activities. Alternatively, monitoring can be performed at the server-side to track and/or count served webpages.

### BRIEF DESCRIPTION OF THE DRAWINGS

FIG. 1 is a block diagram of an example system constructed in accordance with the teachings of this disclosure to monitor Internet traffic.

FIG. 2 is a more detailed block diagram of the example browser monitor of FIG. 1.

FIG. 3 is a more detailed block diagram of the example monitoring data collection site of FIG. 1.

FIG. 4 is a diagram of example collected Page Info data.

FIG. 5A is a table illustrating an example event log.

FIG. 5B is a table illustrating an example browser window life span and/or browser history log for a browser window.

FIG. 6 is a flowchart representative of example computer readable instructions which, when executed, cause a processor to implement the example monitoring data collection site of FIG. 1 to identify a pop-up browser window on a monitored device.

FIG. 7 is a flowchart representative of example computer readable instructions which, when executed, cause a processor to implement the example monitoring data collection site of FIG. 1 to determine which of multiple browser windows is a pop-up or pop-under window.

FIG. 8 is a block diagram of an example processor platform 800 capable of executing the instructions of FIGS. 6 and/or 7 to implement the apparatus of FIGS. 1, 2, and/or 3.

Wherever possible, the same reference numbers will be used throughout the drawing(s) and accompanying written description to refer to the same or like parts.

### DETAILED DESCRIPTION

Internet monitoring systems may be implemented in various configurations based on the data that is intended to be collected. For example, a server hosting a server-based Internet monitoring system tracks how users interact with that server. The resulting server-based monitoring data includes detailed information about how users utilize that particular server and/or Internet domain, but will not provide data on how the users interact with other servers in other domains. Proxy server based Internet monitoring systems track how a group of users interact with a plurality of servers hosting any number of websites in any number of domains. For example, an Internet service provider that manages a proxy server to serve web pages may utilize the proxy server to monitor what websites users utilizing the proxy visit while using the Internet service. Client-side Internet monitoring systems monitor the Internet activity of a specific user who is operating a browser on a client computer. In such client-side Internet monitoring systems, monitoring data that is collected by the system can be very detailed due to the ability to monitor system calls and/or applications (e.g., a browser, a word processing program) being run locally on the client computer, the ability to track interactions with input devices (e.g., mouse clicks and/or movements, keystrokes on a keypad, etc.), the ability to detect access to cached media (e.g., a previously loaded webpage accessed from memory rather than from a fresh request to the Internet), and/or the ability to identify the user associated with the client device. Client-side monitoring thereby allows a wide range of web sites to be monitored while adding the ability to associate web usage data with specific users, groups of users and/or demographic; and allows collecting of more parameters and/or accurate monitoring data.

A browser is used to view Internet media (e.g., content and/or advertisements) on a client computer. To obtain Internet media, the browser sends an HTTP (Hypertext Transfer Protocol) request for the media to a server at an Internet address specified by a Universal Resource Locator (URL). The server sends a response containing the requested media and/or links to the requested media and/or other media (e.g., an ad) to the browser. The browser then proceeds to render the media and/or additional media for presentation (e.g., display) to the user. The user may then interact with the browser and/or the rendered media. The browser can be any Internet browsing application. For example, the browser may be Microsoft Internet Explorer®, Mozilla Firefox®, Apple Safari®, Google Chrome™, etc. Additionally or alternatively, the user may utilize multiple browsers simultaneously to view multiple web pages. Further, the browser may not be a standard Internet browser as listed above, rather the browser may be integrated into another application on the user's computer.

Users typically view media (e.g., one or more webpages) in a browser for a given time period. This period is known as a browsing session. Browsing sessions can be any duration. For example, a user may use their browser to check a weather forecast on a first webpage, during a browsing session that may only last a few minutes, or even a matter of seconds. If, instead, the user accesses the weather on the first webpage and then reads a long article or series of articles on one or more other webpages, the duration of the browsing session may be many minutes or even over an hour. In the examples illustrated herein, a browsing session is defined as the time period that the browser was running irrespective of how many webpages are accessed during the time period. The user may start the browsing session by, for example, starting the browser, and may terminate the browsing session by, for example, exiting the browser and/or bringing another application to the foreground of the computer (e.g., bringing another application into focus).

Client-side monitoring of Hypertext Transfer Protocol (HTTP) traffic generated by a user is performed in order to determine the user's Internet usage habits, and can be beneficial to media monitoring and advertising companies. HTTP monitoring data typically includes the identity of web pages viewed by the user, an indication of the time(s) that the user viewed the web pages (e.g., a timestamp(s)) and/or an identity of the client machine and/or a user of the client machine.

Example methods and apparatus disclosed herein identify pop-up windows and/or pop-under windows on a monitored device. Example methods and apparatus disclosed herein identify the pop-up windows and/or pop-under windows based on event logs generated by a browser monitor, such as a computer activity monitoring application or process. By identifying pop-up windows and/or pop-under windows, example methods and apparatus increase the accuracy of online monitoring by reducing impression counts related to pop-up windows and/or pop-under windows that are not desired by and/or are ignored by users.

Example methods and apparatus disclosed herein identify a pop-up window or a pop-under window by identifying web page load events corresponding to a user action on a monitored device, identifying a life span and/or a page load history of a first browser window, and determining that the first browser window is a pop-up window or a pop-under window based on the life span and/or the page load history. In some examples disclosed herein, methods and apparatus identify the web page load events by identifying at least two web page load events occurring between adjacent user actions. In some examples, methods and apparatus disclosed herein identify the web page load events corresponding to a user action by identifying the user action and the web page load events in an event log from the monitored device.

Example methods and apparatus disclosed herein identify the life span of the first browser window by identifying a window open event (e.g., opening or creating a browser window) and a window close event (e.g., closing or destroying the browser window) that correspond to a window identifier of the first browser window. In some example methods and apparatus, the first browser window is identified as a pop-up window or a pop-under window by determining that the time between the window open event and the window close event is less than a life span of a different window (e.g., a browser window of interest to the user). In some examples, the second window is determined based on one of the web page load events.

Example methods and apparatus disclosed herein identify the page load history by identifying one or more web pages loaded in the first browser window between a browser window open event and a browser window close event for the first browser window. In some examples methods and apparatus disclosed herein, the first browser window is identified as a pop-up window based on the page load history having one web page load. Example methods and apparatus disclosed herein identify at least one of a second life span or a second page load history of a second browser window, and determine that the first browser window is a pop-up window based on at least one of the second life span or the second page load history.

As used herein, the term “parent web page” refers to a web page that causes the generation of a pop-up web page or a pop-under web page (e.g., via instructions, script, or other computer readable code included in or invoked by the parent web page document, such as in HTML code rendered by a browser application to display the parent web page). As used herein, the term “pop-up window” refers to a browser window that is programmatically created and immediately has focus on the device (e.g., takes focus from a browser window with which the user was interacting). As used herein, the term “pop-under window” refers to a browser window that is programmatically created, but does not take focus from another browser window (e.g., opens in a background of the user device, while retaining focus on the window with which the user was interacting). As used herein, the term “parent browser window” refers to the browser window or browser instance that loads the parent web page. As used herein, the term “child web page” refers to the pop-up web page or a pop-under web page created by the parent web page. As used herein, the terms “secondary browser window,” “child browser window,” “pop-up window,” and “pop-under window” refer to a browser window or browser instance that loads the child web page. A “secondary browser window” or “child browser window” may be either a pop-up window or a pop-under window. As used herein, the parent web page is considered to be the “parent” of pop-up web pages and/or pop-under web pages that occur during the browsing session, and a pop-up web page or a pop-under web page is considered to be a “child” of the parent web page that caused its creation and/or loading in the child browser window.

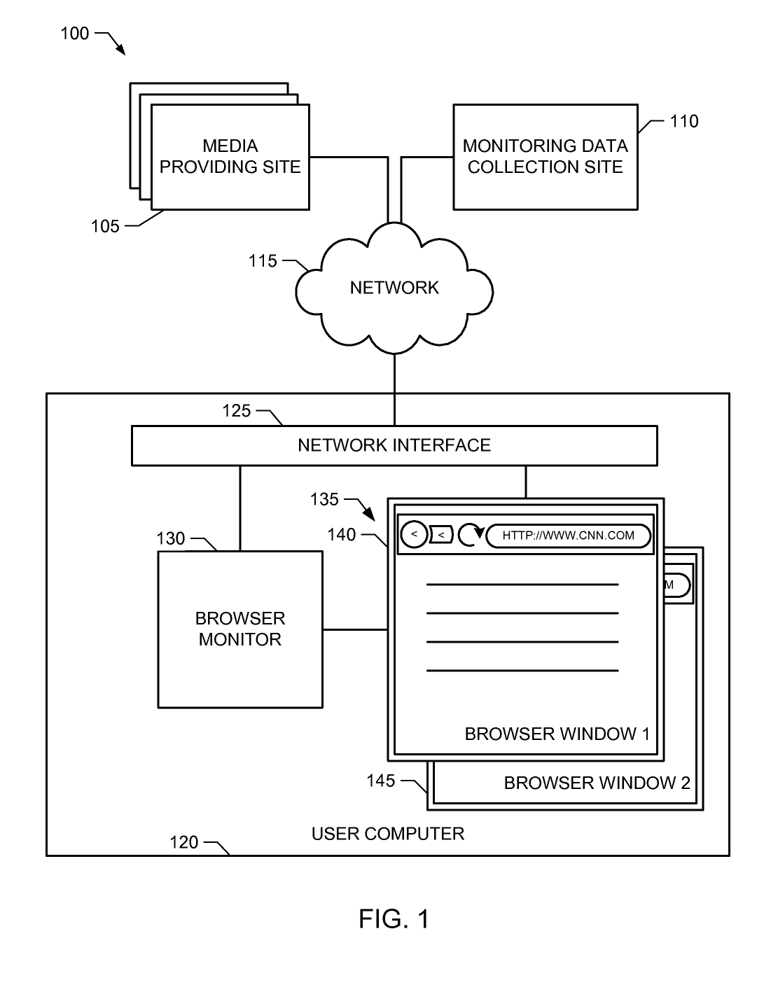

FIG. 1 is a block diagram of an example system 100 constructed in accordance with the teachings of this disclosure to monitor Internet traffic. The example system 100 includes a media providing server 105, a monitoring data collection server 110, a network 115, a user (e.g., a client) computer 120, a network interface 125, a browser monitor 130, and a browser 135. The browser 135 of the illustrated example includes multiple browser windows 140, 145. The example media providing server 105 provides media to the browser 135 in response to an HTTP request. There may be multiple media providing servers 105 identified by different Internet Protocol (IP) addresses and serving different media (e.g., content and/or ads). For example, in a single session it is likely that the browser 135 (e.g., the browser window(s) 140, 145) will communicate with multiple media providing sites 105. For example, in a single browser session a user may check their email from a first server 105, read a news article served or hosted by a second server 105, and check the weather from a third server 105. The media provider sites 105 may be linked, wherein media from one site is displayed on another site as part of a composite webpage. For example, an email portal media provider site may have a weather widget displaying weather data from a weather provider site in a window or other portion of a webpage simultaneously displaying the email content.

A user of the browser 135 navigates to different web pages provided by the different media providing site(s) 105 via different interactions with the computer 120 (e.g., user actions), such as: manipulating and/or clicking a mouse or other type of input device (e.g., touchpad, trackball, etc.); using a keyboard to input and/or enter character data (e.g., text, numbers, symbols, etc.), and/or to navigate media displayed in the browser 135; using voice recognition and/or voice commands to translate user-spoken words into commands and/or data; using touchscreens to implement or simulate a keyboard or cursor; and/or using any other type of user input device.

In the example of FIG. 1, the monitoring data collection server 110 is a site to which the browser monitor 130 reports data. In the illustrated example, the monitoring data collection site 110 is a neutral third party site that does not provide the monitored media to client devices 120 and/or is not involved with delivering media from the media providing site(s) 105 to the client device 120. The monitoring data collection site 110 may be associated with an audience measurement and/or web analytics company, such as The Nielsen Company (US), LLC. The monitoring data collection site 110 may receive data in any fashion. In the illustrated example, monitoring data is transmitted from the browser monitor 130 to the monitoring data collection site 110 by File Transfer Protocol (FTP) communication. Any other system or protocol for transmitting data may additionally or alternatively be used. For example, the data may be transmitted by an HTTP GET request, wherein the request includes the collected data, or some other data transfer or transmission protocol. The monitoring data collection site 110 may process the monitoring data before storing the data, or it may store the data as it is received.

The network 115 of the illustrated example is the Internet. However, any other network could be used. For example, some or all of the network 115 may be a company's intranet network. Although the network 115 of the illustrated example operates based on the HTTP and IP protocols, the network 115 may additionally or alternatively use any other protocol to enable communication between devices on the network.

The user computer 120 of the illustrated example is a personal computer. However, any other type of computing device could be used to implement the computer 120 such as, for example, a mobile (e.g., cellular) phone, a personal digital assistant (PDA), Internet appliance, tablet (e.g., iPad™), etc. The user of the illustrated example is a panelist who has agreed to participate in a study. Although the example system of FIG. 1 is a panelist-based system, other non-panelist and/or hybrid panelist systems may be employed. In the panelist system of the illustrated example, demographic information is obtained from the user when the user joins and/or registers for the panel. The demographic information may be obtained from the user via a telephone interview, by having the user complete an online survey, etc.

The network interface 125 is an interface that allows applications running local to the computer 120 to communicate with external sites via the network 115. In the illustrated example, the network interface 125 is a wired Ethernet port. However, any other type of network interface may be used. For example, a WiFi 802.11x wireless network port, a Bluetooth network adapter, or a cellular modem may be used. Additionally or alternatively, there may be multiple network interfaces in any combination of types.

In the illustrated example, the browser 135 presents Internet media (e.g., web pages, ads, streaming media, etc.) to the user. The browser monitor 130 monitors user activity on the computer 120, and more specifically monitors user interaction with the browser 135. When executing, the example browser 135 of FIG. 1 includes one or more browser windows. Two example windows 140, 145 are illustrated in FIG. 1. In some browser applications, the browser windows 140, 145 execute as independent instances of the browser application 135. Example browsers 135 that may be monitored include Mozilla Firefox®, Microsoft Internet Explorer®, Apple Safari®, Google Chrome™, and/or any other browser application.

In the illustrated example of FIG. 1, the browser monitor 130 is an application executed on the computer 100. The application is loaded and/or downloaded on the computer 100 upon receiving user consent. The consent may be obtained via the registration process (e.g., when the user is interviewed to join the panel, when the user completes an online survey to join the panel, etc.) The application may be downloaded via the Internet or sent to the user via a compact disc (CD) or a digital versatile disc (DVD), a Blu-ray disc, or any other computer readable storage medium storing the machine-readable instructions constituting the application. However alternative architectures or implementations may also be employed such as, for example, embedding the browser monitor in the browser 135 (e.g., a browser plug-in, JavaScript, etc.), monitoring browser activity from a remote site such as the monitoring data collection site 110, etc.

While the example of FIG. 1 illustrates only one client device 120, multiple client devices 120 (each monitored by a separate browser monitor 130) may be present. In such examples, the client devices 120 may be associated with different panelists, households, locations, and/or groups of panelists (e.g., a family). Similarly, while FIG. 1 illustrates one collection site 110, more than one collection server 110 may be employed and/or the collection server may be organized into hierarchical and/or geographic regions.

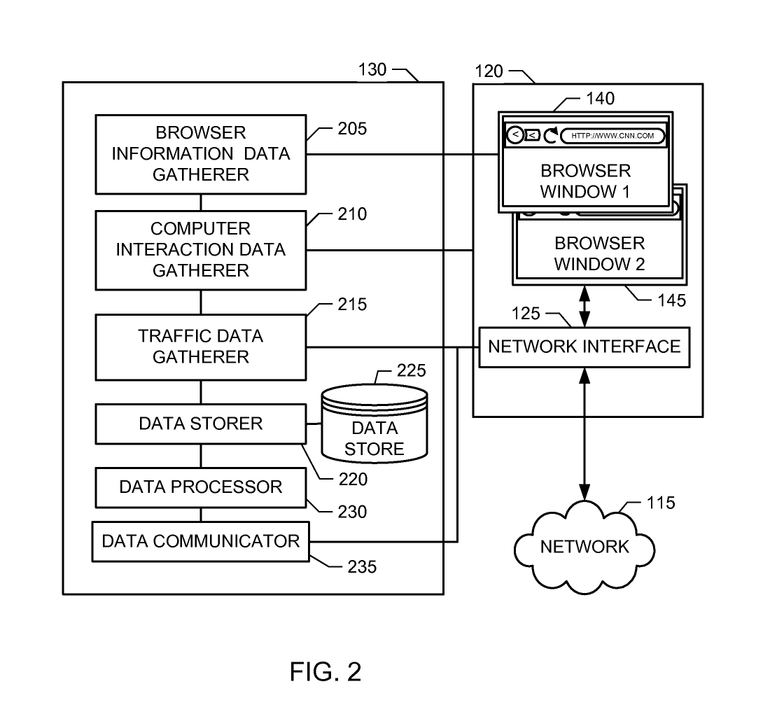

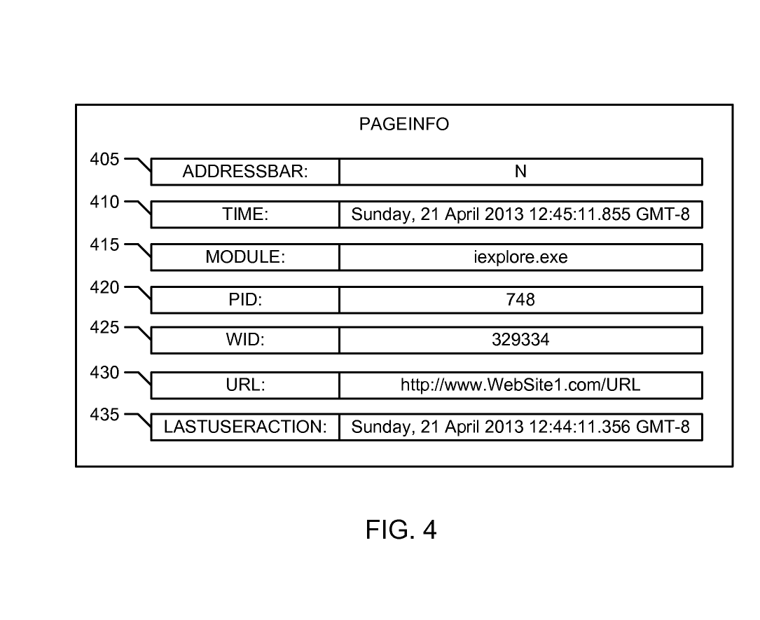

FIG. 2 is a block diagram of an example implementation of the example browser monitor 130 of FIG. 1. The example browser monitor 130 includes a browser information data gatherer 205, a computer interaction data gatherer 210, a Hypertext Transfer Protocol (HTTP) traffic data gatherer 215, a data storer 220, a data store 225, a data processor 230, and a data communicator 235. The browser information data gatherer 205 gathers browser information data from the browser 135, allowing browser properties and currently displayed data to be collected for analysis. In the illustrated example, the browser information data gatherer 205 collects Page Info data (e.g., data describing a web page requested and/or received by the browser 135, such as a URL, an encoding scheme, a size, a timestamp, etc.) from the browser 135 as well as information on the active window of the browser 135. Example Page Info data are illustrated and described below with reference to FIG. 4. However, other data may also be gathered from the browser such as, for example, browser cookies, installed plug-ins, and/or information related to the browser 135 and/or the browser windows 140, 145.

In the example of FIG. 2, the example browser information data gatherer 205 hooks the browser 135 to identify browser window open events or actions, browser window close events or actions, and/or other events or actions occurring at the browser 135. Example methods to hook the browser 135 are described in U.S. Pat. No. 6,115,680, to Coffey et al., the entirety of which is hereby incorporated by reference. The example browser information data gatherer 205 may further determine timestamps of the events, the browser window 140, 145 in which the events occur, and/or any information describing the events (e.g., identifiers of the browser windows 140, 145 in which the events or actions occur).

The computer interaction data gatherer 210 of the illustrated example gathers data related to user interactions with the computer 120. In the illustrated example, the computer interaction data includes events associated with input devices such as the mouse and keyboard (e.g., events such as mouse clicks, mouse movements, keystrokes, trackball movements, track pad movements, touchscreen touches, voice input, etc.), as well as information about whether the browser 135 was in focus (e.g., which of the browser windows 140, 145 was in focus). However, any other data of interest may be gathered such as, for example, a list of other applications that are being executed, software versions of applications installed on the computer, focus status of other applications that are being executed, etc. In the illustrated example, events are collected by monitoring operating system events (e.g., via a keyboard or mouse hook). However, any other methods of monitoring operating system events may additionally or alternatively be used such as, for example, monitoring operating system files or memory, using an operating system API, etc.

The traffic data gatherer 215 of the illustrated example gathers HTTP traffic data sent and/or received by the user computer 120. In the illustrated example, the traffic data gatherer 215 gathers clickstream data by monitoring the network interface 125 for HTTP requests and responses. Alternatively, HTTP traffic data may be gathered directly from the browser 135 via a browser plug-in that records HTTP traffic. The example traffic data gatherer 215 filters HTTP traffic based on a library of terms of interest so that only items matching a specific type (e.g., messages including an HTTP reply) are recorded. However, the traffic data gatherer 215 may alternatively be configured to collect/record all HTTP traffic or may use some other sort of filter. In the illustrated example, HTTP traffic data includes any message from one computer to another. Such messages often include a Universal Resource Locator (URL). Additionally, the HTTP traffic data may include data identifying the originating software application. For example, the HTTP traffic data may indicate that the originating software application is a word processing application (e.g., Microsoft Word®) automatically (e.g., in response to an expired timer) requesting updates from a server via an HTTP request. In such circumstances, the traffic data gatherer 215 of some examples will disregard the HTTP traffic, as it does not relate to user interaction with the browser 135.

In some examples, the traffic data gatherer 215 hooks the browser windows 140, 145 to monitor for web page load events. For example, the traffic data gatherer 215 intercepts designated events in the browser 135 (e.g., events in the browser windows 140, 145). Example methods to hook the browser 135 are described in U.S. Pat. No. 6,115,680. The example traffic data gatherer 215 may further determine timestamps of the events, the identities of the browser window 140, 145 in which the events occur, and/or any information describing the events (e.g., a URL for a web page load event).

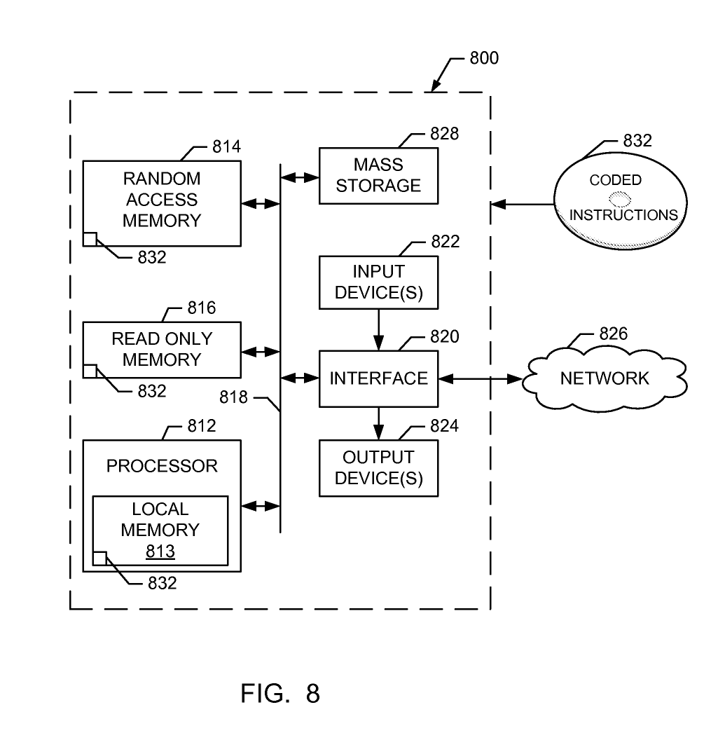

The example data storer 220 of FIG. 2 is implemented by a processor (e.g., the processor 800 of FIG. 8) executing instructions, but it could alternatively be implemented by an Application Specific Integrated Circuit (ASIC), a Digital Signal Processor (DSP), a Field Programmable Gate Array (FPGA), and/or any other circuitry. The data storer 220 of the illustrated example receives monitoring data from the browser information data gatherer 205, the computer interaction data gatherer 210, and the traffic data gatherer 215, and stores the received data in the data store 225. The data store 225 of the illustrated example may be implemented by any storage device and/or storage disc for storing data such as, for example, solid-state memory, flash memory, magnetic media such as a hard disk drive, random access memory, optical media such as a compact disc (CD) or a digital versatile disc (DVD), etc. Furthermore, the data stored in the data store 225 may be in any data format such as, for example, binary data, comma delimited data, tab delimited data, structured query language (SQL) structures, etc.

The example data processor 230 of FIG. 2 is implemented by a processor executing instructions, but it could alternatively be implemented by an ASIC, DSP, FPGA, and/or other circuitry. The data processor 230 of the illustrated example parses the data stored in the data store 225 by the data storer 220 to determine which websites were viewed and how long each of the web sites were viewed. In the illustrated example, the data processor 230 uses HTTP traffic data, clickstream data (e.g., mouse and keyboard data), application focus data, and/or active tab data to determine what web site a user was presented, and/or how long the web site was presented. Further, the data processor 230 may store additional data in the data store 225 such as, for example, classification data and/or crediting data. Although the example of FIG. 2 illustrates the data processor 230 as a component of the browser monitor 130, in other examples, the data processor 230 may be a component of the data collection site 110.

The example data communicator 235 of FIG. 2 is implemented as an Ethernet interface. However, any other method(s) of implementing the data communicator could alternatively be used. For example, the data communicator 235 may represent a TCP/IP stack. The data communicator communicates with the monitoring data collection site 110 to report the monitoring data collected by the browser monitor 130.

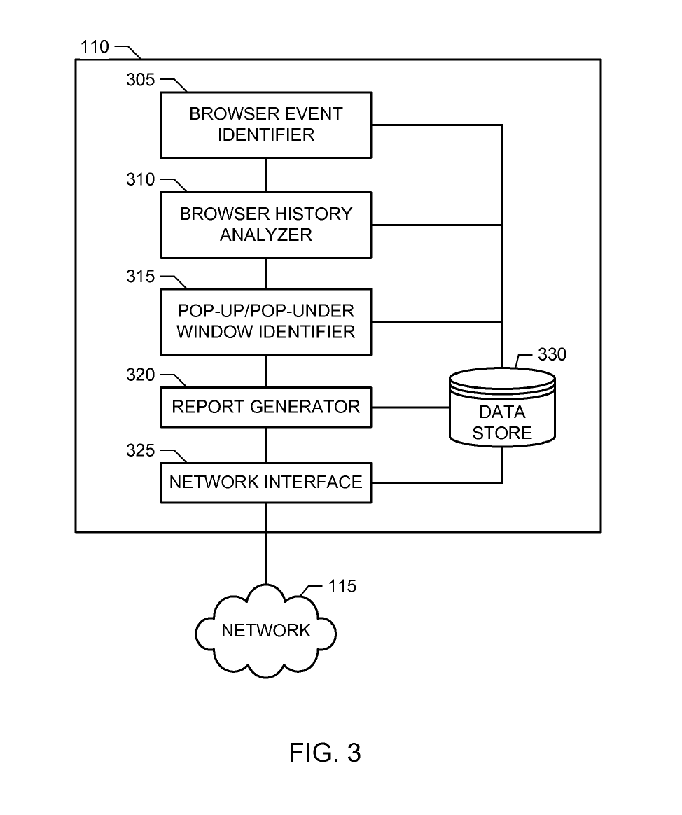

FIG. 3 is a block diagram of an example implementation of the monitoring data collection site 110 of FIG. 1. The example monitoring data collection site 110 of FIG. 1 includes a browser event identifier 305, a browser history analyzer 310, a pop-up window identifier 315, a report generator 320, a network interface 325, and a data store 330. The example monitoring data collection site 110 obtains (e.g., receives) event logs or browser activity logs from monitors (e.g., the monitors 130) loaded on user devices such as the user computer 120 of FIG. 1 via the network 115.

The example browser event identifier 305 of FIG. 3 identifies events in an event log or browser activity log (e.g., received from the user computer 120 of FIGS. 1-2). For example, the browser event identifier 305 identifies web page load events (e.g., two or more web page load events) that correspond to a single user action. In general, child pop-up web pages and/or pop-under web pages are created or initialized immediately upon loading of the parent web page (e.g., as part of executing and/or rendering the code of the parent web page). When a parent web page (e.g., a web page selected by a user) causes a child pop-up window or a pop-under window to be generated (which then loads a web page), the event log may include a user action event at a first time followed by two web page load events (e.g., one for the user-selected web page in a first browser window, and one for the pop-up page in a different browser window) before the next user action occurs. In the example of FIG. 3, the event log further includes timestamps of the web page load events and the user actions.

When the browser event identifier 305 identifies two or more web page load events occurring between time-adjacent user actions (e.g., based on the timestamps of the web page load events and user actions), the example browser event identifier 305 determines that a pop-up window or a pop-under window has occurred. For example, the browser event identifier 305 may identify a first user action (e.g., a mouse click, a series of keystrokes followed by a selection or entry keystroke, etc.) at a first time in the event log. The example browser event identifier 305 may further identify a subsequent time-adjacent user action (e.g., the next user action following the first identified user action). Based on the two identified time-adjacent user actions, the example browser event identifier 305 determines a number of web page load events (e.g., via hooking the browser 135) that occurred at the user computer 120. If two or more web page load events occurred at the user computer 120 between the time-adjacent user actions, the example browser event identifier 305 determines that the one or more of the web page load events represent the creation of a pop-up window or a pop-under window.

The example browser history analyzer 310 of FIG. 3 analyzes the event logs to determine the web page histories and/or the life spans of the browser windows 140, 145 on the user computer 120. For example, the browser history analyzer 310 of FIG. 3 identifies the life spans of the browser windows 140, 145 by identifying window open event(s) and/or window close event(s) that correspond to same browser window identifiers. The example browser history analyzer 310 of the illustrated example constructs logs representative of the life spans of individual browser windows 140, 145, including the creation of the browser window 140, 145, the web pages loaded in the browser window 140, 145, the user actions in the browser window 140, 145, the time period(s) in which the browser window 140, 145 was in focus, and/or the destruction of the browser window 140, 145.

When the example browser event identifier 305 of FIG. 3 determines that a pop-up window or pop-under window has occurred, the example browser history analyzer 310 identifies a life span and/or a page load history of the browser windows 140, 145 from a log of browser events of the user computer 120. The example browser event identifier 305 and/or the example browser history analyzer 310 determine that the potential pop-up or pop-under windows are the browser windows that are associated with two or more web page load events between time-adjacent user actions. For example, the example browser history analyzer 310 determines that life span (e.g., a time between the window open event (e.g., creation) and the window close event (e.g., destruction)) of one of the potential pop-up or pop-under windows (e.g., the browser window 145) is less than the life span(s) of other potential pop-up or pop-under window(s) (e.g., the window 140). The example browser history analyzer 310 determines to which of the other browser windows the window 140 is to be compared based on, for example, browser identifiers associated with web page load events occurring between time-adjacent user actions.

Additionally or alternatively, the example browser history analyzer 310 of FIG. 3 identifies the page load history by identifying a web page loaded in the browser window 140, 145 between a browser window open event (e.g., creation) and a browser window close event (e.g., destruction)for the browser window 140, 145.

The example pop-up/pop-under window identifier 315 of FIG. 3 determines which of the browser windows 140, 145 that are potentially a pop-up or pop-under window (e.g., the browser windows 140, 145) is the pop-up or pop-under window. For example, the pop-up/pop-under window identifier 315 determines which of the browser windows 140, 145 is a pop-up window based on the life spans of the browser windows 140, 145 and/or the page load histories of the browser windows 140, 145. For example, the pop-up/pop-under window identifier 315 of FIG. 3 determines that the browser window 145 is a pop-up or pop-under window based on the page load history of the browser window 145 having one web page load. For example, an unwanted pop-up or pop-under window is typically closed by a user without further interactions with the pop-up or pop-under window.

Additionally or alternatively, the example pop-up/pop-under window identifier 315 may determine which of the browser windows 140, 145 is the pop-up/pop-under window by comparing the life spans of the browser windows 140, 145. The example pop-up/pop-under window identifier 315 determines that the browser window 140, 145 that has the shortest life span is the pop-up/pop-under window, because users tend to close pop-up windows right away rather than closing the parent window (e.g., the window that includes the requested media).

The example pop-up/pop-under window identifier 315 may additionally or alternatively determine which of the browser windows 140, 145 are not pop-up/pop-under windows based on the life spans and/or the page load histories of the browser windows 140, 145. For example, the pop-up/pop-under window identifier 315 may determine that the browser window 140 is not a pop-up/pop-under window based on the browser window 140 having multiple web page load events and/or based on the browser window 140 having a longer life span than another potential pop-up/pop-under window (e.g., the browser window 145).

The example pop-up/pop-under window identifier 315 may use a combination of any or all of the example criteria, factors, and/or tests disclosed above to determine whether a window is a pop-up window, a pop-under window, or neither.

The example report generator 320 of FIG. 3 generates reports of online activities and/or media impressions for the user computer 120. In the generated reports, the example report generator 320 may include indications of pop-up/pop-under windows in the impressions data and/or may exclude impressions corresponding to the detection of pop-up/pop-under windows.

The example network interface 325 is an interface that the example monitoring data collection site 110 employs to communicate with external devices (e.g., the user computer 120) via the network 115. For example, the network interface 325 may enable receiving monitoring data (e.g., event logs) from the user computer 120 and/or transmissions of reports generated by the report generator 320. The example network interface 325 may be similar or identical to the example network interface 125 of FIG. 1.

The example data store 330 of FIG. 3 stores event logs, generated reports, browser window life span logs, and/or any other data that may be used to identify pop-up/pop-under windows. The example browser event identifier 305, the example browser history analyzer 310, and/or the example pop-up/pop-under window identifier 315 of FIG. 3 may access the data store 330 to obtain the event logs, from which pop-up/pop-under windows may be identified. The example report generator 320 of FIG. 3 stores generated reports in the data store 330 until, for example, a time at which the reports are to be provided to an external party or device.

FIG. 4 is a diagram of example collected Page Info data 400. The example Page Info data 400 is collected from the browser 135 by the browser monitor 130, and includes an addressbar field 405, a timestamp field 410, a module identification field 415, a process identifier (PID) field 420, a window identifier (WID) field 425, a URL field 430, and a last_user_action field 435. Any other fields may be included in the Page Info data 300 such as, for example, a metadata field, page rendering type fields, a page title field, a resizability field, a size field, a tab identifier field, etc. The browser 135 derives the fields from hooks into the browser 135.

The example addressbar field 405 of FIG. 4 describes whether an address bar of the identified browser window is enabled (e.g., whether the address bar may be manipulated by the user). The timestamp field 410 of FIG. 4 describes the time and date at which the web page was requested. The module field 415 of FIG. 4 indicates the browser application used. The PID field 420 of FIG. 4 indicates the identification of the process assigned to the browser 135 and/or to the browser window identified in the window ID field 425. The window ID field 425 of FIG. 4 indicates a unique identifier for the browser window in which the web page is loaded.

The URL field 430 of the illustrated example provides the URL of the web page being loaded. The last_user_action field 435 of FIG. 4 provides a time at which the last user action was performed. In some examples, the last_user_action field 435 is further limited to the last user action performed on the process identified in the PID field 420.

In some examples, the browser event identifier 305 of FIG. 3 identifies logged user actions that are captured by hooking the browser 135. In some other examples, the browser event identifier 305 identifies instances of multiple page load events occurring between time-adjacent user actions by comparing the last_user_action fields from the Page Info data. For example, the browser event identifier 305 determines whether multiple web page load events have the same last_user_action field values and/or whether multiple timestamps from the Page Info data occur between time-adjacent last_user_action field values.

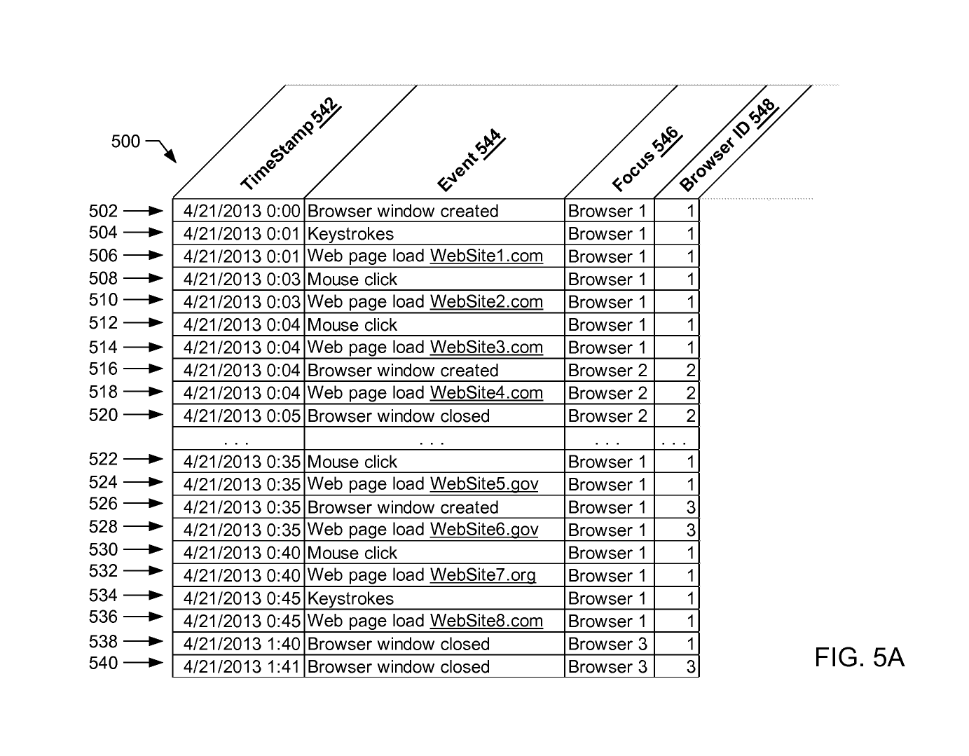

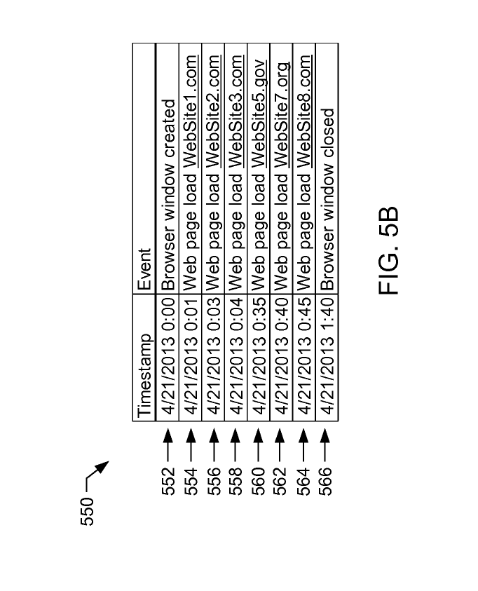

FIG. 5A is a table illustrating an example event log 500. The example event log 500 of FIG. 5A may be generated by the example browser monitor 130 of FIGS. 1 and/or 2 for delivery to and/or processing by the example monitoring data collection site 115 of FIGS. 1 and/or 3. The example event log 500 includes entries 502-540 generated by the browser monitor 130 in response to detecting monitored events in the browser 135 of FIG. 1. The example entries 502-540 include respective timestamps 542, event identifiers 544, a focused application 546 on the user computer 120 at the time of the event, and a browser identifier 548 of the browser in which the event occurred.

At the example event 502, the browser window (e.g., Browser 1) is created. For example, event 502 may occur when the user first starts the browser application 135. At the example event 504, a user enters a series of keystrokes into Browser 1 after which, at event 506, Browser 1 loads the web page WebSite1.com (which was or may have been specified by the keystrokes). At the example event 508, the user clicks the mouse in Browser 1 after which, at event 510, Browser 1 loads the web page WebSite2.com (which may correspond to the selection made by the mouse).

Subsequently, the user clicks the mouse in Browser 1 at event 512, after which Browser 1 loads the web page WebSite3.com (which may correspond to the click at event 512). Additionally, a new browser window (e.g., Browser 2) is created at event 516. At event 516, focus also changes from Browser 1 to Browser 2. The change in focus at the creation of Browser 2 suggests that the example Browser 2 is a pop-up window (rather than a pop-under window). Browser 2 proceeds to load the web page WebSite4.com at event 518. WebSite4.com may be loaded in response to executing code in the web page source for WebSite3.com. At event 520, Browser 2 is closed (while Browser 1 remains open).

At example event 522, the user clicks the mouse in Browser 1 and, at event 524, Browser 1 loads web page WebSite5.gov in response to the user clicking the mouse in Browser 1. Additionally, a new browser window (e.g., Browser 3) is created at event 526. However, unlike at event 516, focus remains on Browser 1. The unchanging focus at the creation of Browser 3 suggests that Browser 3 is a pop-under window (rather than a pop-up window). The example Browser 3 loads the web page WebSite6.gov at event 528 in response to executing code in the web page source for WebSite5.gov.

At event 530, the user clicks the mouse in Browser 1. At event 532, Browser 1 loads the web page WebSite7.org in response to the user clicking the mouse in Browser 1. At event 534, the user enters a series of keystrokes into Browser 1. At event 536, Browser 1 loads the web page WebSite8.org in response to the keystrokes in Browser 1. During events 530-536, Browser 3 remains in the background (e.g., not in focus), while the example Browser 1 remains in focus. At block 538, Browser 1 is closed and focus shifts to Browser 3. At block 540, Browser 3 is closed (e.g., the browser application 135 is closed).

The example browser event identifier 305 of FIG. 3 identifies user actions in events 504, 508, 512, 520, 522, 530, 534, 538, and 540. The example browser event identifier 305 determines that closing the browser windows at events 520, 538, and 540 are user actions. In some other examples, the browser event identifier 305 may not consider closing the browser windows to be user actions. The example browser event identifier 305 also identifies the web page load events at events 506, 510, 514, 518, 524, 528, 532, and 536.

Based on the identified user actions and the identified web page load events, the example browser event identifier 305 identifies instances of multiple web page load events occurring between time-adjacent user actions (e.g., time adjacent ones of the events 504, 508, 512, 520, 522, 530, 534, 538, and 540 corresponding to user event pairs 504-508, 508-512, 512-520, 520-522, 522-530, 530-534, 534-538, and 538-540). Thus, the example browser event identifier 305 identifies a first instance of multiple web page load events including events 514 and 518, corresponding to Browser 1 and Browser 2, between time-adjacent user actions such as the mouse click 512 and the closing of the Browser 2 window 520 (e.g., via a mouse click, keystroke(s), and/or another input method). The example browser event identifier 305 identifies a second instance of multiple web page load events including events 524 and 526 occurring between time-adjacent user actions at events 522 and 530. Based on the identified instances, the example browser event identifier 305 determines that Browser 1 or Browser 2 may instantiate a pop-up/pop-under window during the first instance, and that Browser 1 or Browser 3 may instantiate a pop-up/pop-under window during the second instance.

The example browser history analyzer 310 of FIG. 3 determines a life span of the potential pop-up/pop-under windows Browser 1, Browser 2, and Browser 3. FIG. 5B is a table illustrating an example browser window life span/browser history log 550 for Browser 1. The example table 550 is generated from the events 502-540 of the event log 500 of FIG. 5A. Unlike the example event log 500, the example browser window life span/browser history log 550 is focused on a single browser window (e.g., Browser 1) and omits fields (e.g., omits fields such as the focus field 546 and/or the browser ID field 548) that are not relevant to determining the page load history and/or the life span of the example Browser 1.

The example browser window life span/browser history log 550 of FIG. 5B begins with a creation event 552 for Browser 1 (e.g., corresponding to event 502 of FIG. 5A). The example browser window life span/browser history log 550 further includes events 554-564 corresponding to the web page load events for Browser 1 (e.g., corresponding to respective events 506, 510, 514, 524, 532, and 536 of FIG. 5A).

From the example browser window life span/browser history log 550 and/or from the event log 500, the example browser history analyzer 310 of FIG. 3 may determine the life span of the example Browser 1 (e.g., the length of time between creation and destruction of Browser 1, or 1 hour and 40 minutes) and/or the number of web page load events (e.g., 6 web page load events).

Additionally or alternatively, the example browser history analyzer 310 of FIG. 3 may determine a focus duration for one or more of the browser windows from the example browser window life span/browser history log 550 and/or from the event log 500. In some examples, the browser history analyzer 310 determines which of multiple browser windows is a pop-up window or pop-under window based at least partially on which of the browser windows has the focus (e.g., is at the foreground) of the user device for less than a threshold amount of time (e.g., a shortest length of time of multiple candidate browser windows).

The example pop-up/pop-under window identifier 315 of FIG. 3 compares the example life span and/or the example number of web page load events of Browser 1 to the life span(s) and/or the number(s) of web page load events for the other potential pop-up/pop-under windows Browser 2 and/or Browser 3 to determine which of the browser windows is a pop-up/pop-under window. In the example of FIGS. 5A and 5B, the example pop-up/pop-under window identifier 315 determines that Browser 2 is a pop-up window due to a longer life span of Browser 1 than Browser 2 and/or due to Browser 2 having a single web page load event, and due to the change in focus when Browser 2 was created. In contrast, the example pop-up/pop-under window identifier 315 determines that Browser 3 is a pop-under window due to a longer life span of Browser 1 than Browser 3 and/or due to Browser 3 having a single web page load event, and because focus did not change from Browser 1 at the time of creation of Browser 3.

The example report generator 320 of FIG. 3 may ignore and/or highlight impressions corresponding to Browsers 2 and/or 3 in an online activity report. In contrast, the example Browser 1 is determined to be a user-desired browser window, and the example report generator 320 may process the impressions corresponding to Browser 1 as impressions (subject to other compensation and/or correction).

While an example manner of implementing the system 100 of FIG. 1 is illustrated in FIGS. 1-3, one or more of the elements, processes and/or devices illustrated in FIGS. 1-3 may be combined, divided, re-arranged, omitted, eliminated and/or implemented in any other way. Further, the example media providing site 105, the example monitoring data collection site 110, the example network 115, the example user computer 120, the example network interfaces 125, 325, the example browser monitor 130, the example browser 135, the example browser windows 140, 145, the example browser information data gatherer 205, the example computer interaction data gatherer 210, the example Hypertext Transfer Protocol (HTTP) traffic data gatherer 215, the example data storer 220, the example data stores 225, 330, the example data processor 230, the example data communicator 235, the example browser event identifier 305, the example browser history analyzer 310, the example pop-up window identifier 315, the example report generator 320 and/or, more generally, the example system 100 of FIG. 1 may be implemented by hardware, software, firmware and/or any combination of hardware, software and/or firmware. Thus, for example, any of the example media providing site 105, the example monitoring data collection site 110, the example network 115, the example user computer 120, the example network interfaces 125, 325, the example browser monitor 130, the example browser 135, the example browser windows 140, 145, the example browser information data gatherer 205, the example computer interaction data gatherer 210, the example Hypertext Transfer Protocol (HTTP) traffic data gatherer 215, the example data storer 220, the example data stores 225, 330, the example data processor 230, the example data communicator 235, the example browser event identifier 305, the example browser history analyzer 310, the example pop-up window identifier 315, the example report generator 320 and/or, more generally, the example system 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, media providing site 105, the example monitoring data collection site 110, the example network 115, the example user computer 120, the example network interfaces 125, 325, the example browser monitor 130, the example browser 135, the example browser windows 140, 145, the example browser information data gatherer 205, the example computer interaction data gatherer 210, the example Hypertext Transfer Protocol (HTTP) traffic data gatherer 215, the example data storer 220, the example data stores 225, 330, the example data processor 230, the example data communicator 235, the example browser event identifier 305, the example browser history analyzer 310, the example pop-up window identifier 315, and/or the example report generator 320 is/are hereby expressly defined to include a tangible computer readable storage device or storage disk such as a memory, a digital versatile disk (DVD), a compact disk (CD), a Blu-ray disk, etc. storing the software and/or firmware. Further still, the example system 100 of FIG. 1 may include one or more elements, processes and/or devices in addition to, or instead of, those illustrated in FIG. 4, and/or may include more than one of any or all of the illustrated elements, processes and devices.

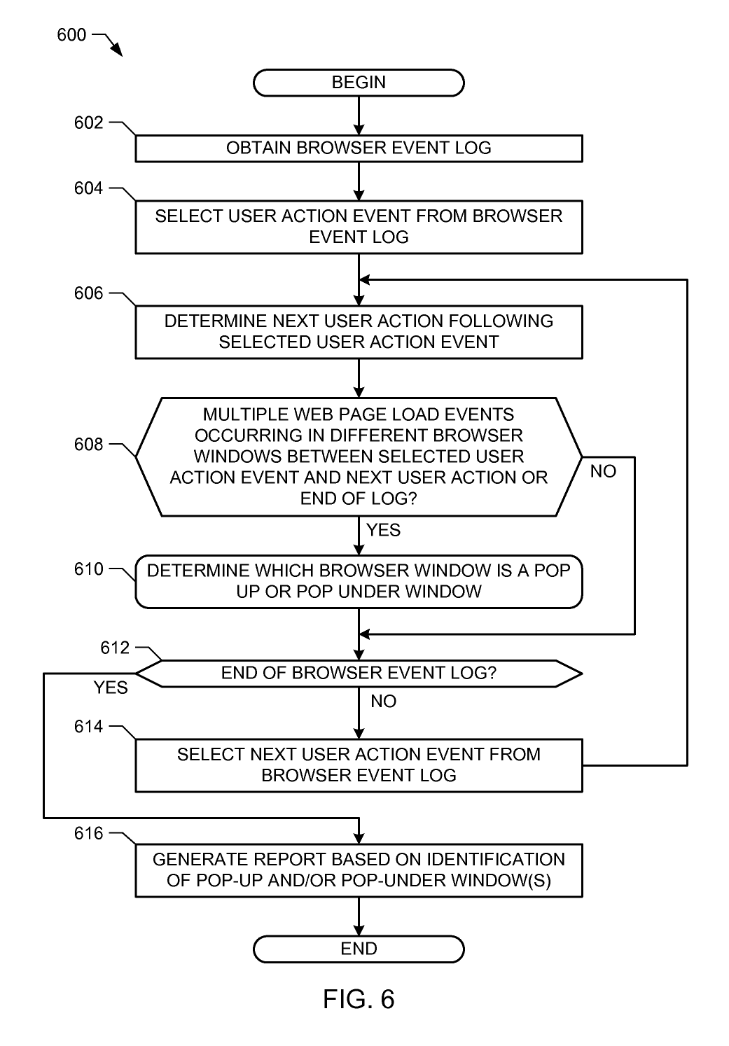

Flowcharts representative of example machine readable instructions for implementing the monitoring data collection site 110 of FIGS. 1 and/or 3 are shown in FIGS. 5 and 6. In this example, the machine readable instructions comprise programs for execution by a processor such as the processor 812 shown in the example processor platform 800 discussed below in connection with FIG. 8. The programs may be embodied in software stored on a tangible computer readable storage medium such as a CD-ROM, a floppy disk, a hard drive, a digital versatile disk (DVD), a Blu-ray disk, or a memory associated with the processor 812, but the entire programs and/or parts thereof could alternatively be executed by a device other than the processor 812 and/or embodied in firmware or dedicated hardware. Further, although the example programs are described with reference to the flowcharts illustrated in FIGS. 6 and/or 7, many other methods of implementing the example monitoring data collection site 110 may alternatively be used. For example, the order of execution of the blocks may be changed, and/or some of the blocks described may be changed, eliminated, or combined.

As mentioned above, the example processes of FIGS. 6 and/or 7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 6 and/or 7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 6 is a flowchart representative of example computer readable instructions 600 which, when executed, cause a processor to implement the example monitoring data collection site 110 of FIGS. 1 and/or 3 to identify a secondary browser window (e.g., a pop-up window or a pop-under window) on a monitored device (e.g., the user computer 120 of FIG. 1).

The example monitoring data collection site 110 (e.g., via the network interface 325 of FIG. 3) obtains a browser event log (block 602). For example, the monitoring data collection site 110 may receive the browser event log from the user computer 120 via the network 115 of FIGS. 1 and/or 3. The example browser event identifier 305 of FIG. 3 selects a user action event from the browser event log (block 604). The browser event identifier 305 determines the next (e.g., subsequent and time-adjacent) user action event following the selected user action event (block 606). For example, the browser event identifier 305 may identify the next user action as the user action following the selection user action event and having the closest time stamp to the time stamp of the selected user action event. The combination of the selected user action event and the next user action event constitutes a user event pair. In some cases, the browser event identifier 305 may identify the end of the log when the selected user action event is the last user action even in the event log.

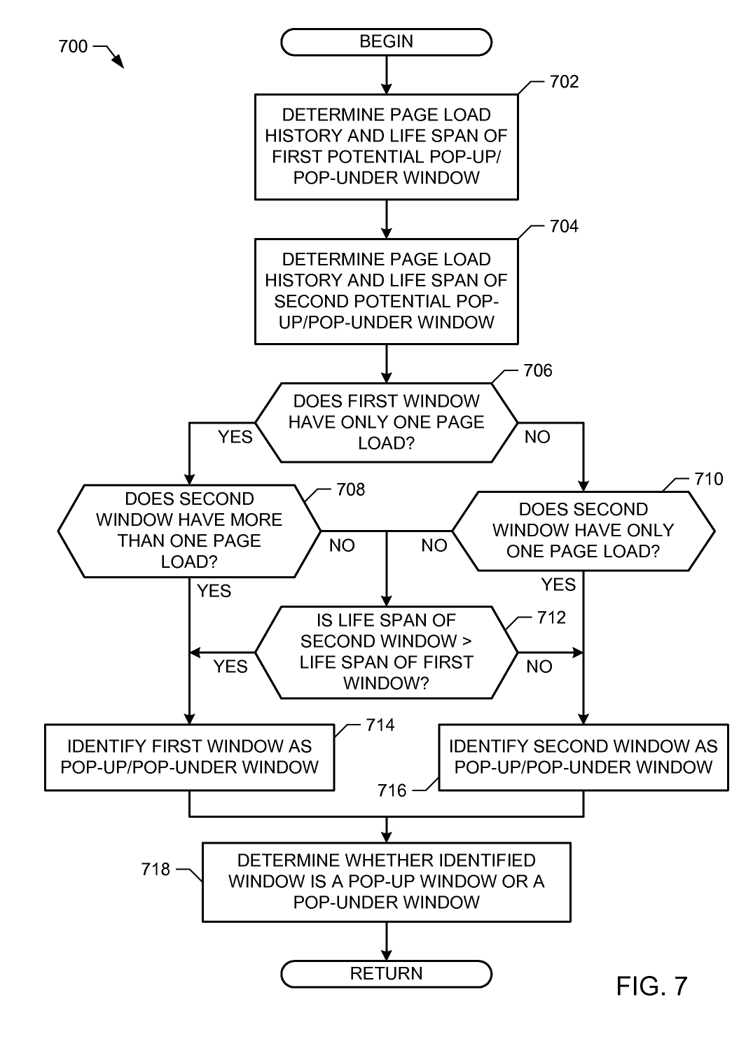

The example browser event identifier 305 determines whether multiple web page load events have occurred in different browser windows between the selected user action event and the next user action or the end of the event log (e.g., between the pair of user events) (block 608). If multiple web page load events have occurred in different browser windows between the selected user action event and the next user action or the end of the event log (block 608), the example browser history analyzer 310 and/or the example pop-up/pop-under window identifier 315 of FIG. 3 determine which browser window is a pop-up or a pop-under window (block 610). Example instructions to implement block 610 are discussed below with reference to FIG. 7.

After determining which browser window is a pop-up or pop-under window (block 610), or if multiple web page load events have not occurred (block 608), the example browser event identifier 305 determine whether the end of the browser event log has been reached (block 612). If the end of the browser event log has not been reached (block 612), the example browser event identifier 305 selects the next user action event from the browser event log (block 614) and control returns to block 606.

When the end of the browser event log is reached (block 612), the example report generator 320 of FIG. 3 generates a report based on the identification of pop-up and/or pop-under windows in the browser event log (block 616). For example, the report generator 320 may include media impressions associated with the identified pop-up and/or pop-under window(s) with an indication that the media impressions have been identified as pop-up and/or pop-under window(s). Alternatively, the example report generator 320 may generate the report by omitting the media impressions associated with windows identified as pop-up and/or pop-under window(s). The example instructions 600 then end and/or iterate for another user computer and/or browser event log.

FIG. 7 is a flowchart representative of example computer readable instructions 700 which, when executed, cause a processor to implement the example monitoring data collection site 110 of FIGS. 1 and/or 3 to determine which of multiple browser windows is a pop-up or pop-under window. The example instructions 700 of FIG. 7 may be executed to implement block 610 of FIG. 6 to determine which of multiple browser windows is a pop-up/pop-under window.

The example instructions 700 of FIG. 7 begin with an identification of two browser windows that are potential pop-up/pop-under windows. This determination may be made in block 608 of FIG. 6 and passed to the instructions 700 as an input. A first one of the windows is designated as a first potential pop-up/pop-under window, and the other of the windows is designated as a second potential pop-up/pop-under window. The example pop-up/pop-under window identifier 315 of FIG. 3 determines a page load history and a life span of the first potential pop-up/pop-under window (block 702). The example pop-up/pop-under window identifier 315 also determines a page load history and a life span of the second potential pop-up/pop-under window (block 704). The example page load history and/or life spans may be determined based on the example event log 500 and/or the example browser window life span/browser history log 550 of FIGS. 5A and/or 5B.

The example pop-up/pop-under window identifier 315 determines whether the first window has only one page load (block 706). For example, the pop-up/pop-under window identifier 315 may determine a number of page load events in the browser history log 550 for the first window. If the first window has only one page load (block 706), the example pop-up/pop-under window identifier 315 determines whether the second window has more than one page load (e.g., based on a browser history log for the second window) (block 708). On the other hand, if the first window has more than one page load (block 706), the example pop-up/pop-under window identifier 315 determines whether the second window has only one page load (block 710).

If both the first window and the second window have only one page load each (blocks 706 and 708), or if both the first window and the second window have more than one page load each (blocks 706 and 710), the example pop-up/pop-under window identifier 315 determines whether the life span of the second window is greater (e.g., longer) than the life span of the first window (block 712). For example, the times between the opening and closing events of the respective windows may be compared to determine which of the windows has the longer life span.

If the first window has only one page load (block 706) and the second window has more than one page load (block 708), or if the life span of the second window is greater than the life span of the first window (block 712), the example pop-up/pop-under window identifier 315 identifies the first window as a pop-up/pop-under window (block 714). On the other hand, if the first window has more than one page load (block 706) and the second window has only one page load (block 710), or if the life span of the second window is not greater than the life span of the first window (i.e., the life span of the first window is greater than the life span of the second window) (block 712), the example pop-up/pop-under window identifier 315 identifies the second window as a pop-up/pop-under window (block 716).

After identifying the first window (block 714) or the second window (block 716) as a pop-up/pop-under window, the pop-up/pop-under window identifier 315 determines whether the identified window is a pop-up window or a pop-under window (block 718). For example, the pop-up/pop-under window identifier 315 may determine whether the identified window is a pop-up window or a pop-under window based on whether focus (e.g., the focus field 546 in the event log 500 of FIG. 5A) shifts in response to the creation event of the identified window. The example instructions 700 end and control returns to block 612 of FIG. 6.

FIG. 8 is a block diagram of an example processor platform 800 capable of executing the instructions of FIGS. 6 and/or 7 to implement the example monitoring data collection site 110, the example user computer 120, the example browser monitor 130, and/or the example system 100 of FIGS. 1, 2, and/or 3. The processor platform 800 can be, for example, a server, a personal computer, a mobile device (e.g., a cell phone, a smart phone, a tablet such as an iPad™), a personal digital assistant (PDA), an Internet appliance, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIGS. 6-7 may be stored in the mass storage device 828, in the volatile memory 814, in the non-volatile memory 816, and/or on a removable tangible computer readable storage medium such as a CD or DVD.

Example methods and apparatus disclosed herein improve monitoring of online activities by detecting pop-up windows and/or pop-under windows. The detection of pop-up and/or pop-under windows enables more accurate impression counts for online media, such as advertisements, by avoiding counting media impressions that are likely to not result in any meaningful impact on the user (e.g., because the user closes the media immediately and/or ignores the presentation of the media in the pop-up/pop-under window). Examples disclosed herein also enable distinguishing a pop-up window from a pop-under window.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to identify a pop-up or pop-under window in a browser, comprising:
identifying, using a processor, web page load events corresponding to a user action on a monitored device;
identifying, using the processor, at least one of a life span or a page load history of a first browser window; and
determining, using the processor, that the first browser window is a secondary browser window based on at least one of the life span or the page load history.

2. A method as defined in claim 1, wherein identifying the web page load events comprises identifying at least two web page load events occurring between adjacent user actions.

3. A method as defined in claim 1, wherein identifying the web page load events corresponding to the user action comprises identifying the user action and the web page load events in an event log from the monitored device.

4. A method as defined in claim 1, wherein identifying the life span of the first browser window comprises identifying a window open action and a window close action corresponding to a window identifier of the first browser window.

5. A method as defined in claim 4, wherein determining that the first browser window is a secondary browser window comprises determining that a time between the window open action and the window close action is less than a life span of a second browser window, the second browser window being determined based on one of the web page load events.

6. A method as defined in claim 1, wherein identifying the page load history comprises identifying a web page loaded in the first browser window between a browser window open event and a browser window close event for the first browser window.

7. A method as defined in claim 6, wherein determining that the first browser window is a secondary browser window is based on the page load history having exactly one web page load.

8. A method as defined in claim 1, further comprising:
identifying at least one of a second life span or a second page load history of a second browser window; and
determining that the first browser window is a pop-up window based on at least one of the second life span or the second page load history.

9. A method as defined in claim 1, wherein determining that the first browser window is a secondary browser window comprises identifying, from the page load history, multiple web page load events occurring between a pair of user events.

10. An apparatus, comprising:
a browser event identifier to identify web page load events corresponding to a single user action from a log of two or more browser events occurring on a monitored device;
a browser history analyzer to identify at least one of a life span or a page load history of a first browser window from the log of browser events of the monitored device; and
a pop-up window identifier to determine that the first browser window is a secondary browser window based on at least one of the life span or the page load history.

11. An apparatus as defined in claim 10, wherein the browser event identifier is to identify the web page load events by identifying at least two web page load events occurring between adjacent user actions.

12. An apparatus as defined in claim 10, wherein the browser event identifier is to identify the web page load events corresponding to a user action by identifying the user action and the web page load events in an event log from the monitored device.

13. An apparatus as defined in claim 10, wherein the browser history analyzer is to identify the life span of the first browser window by identifying a window open event and a window close event corresponding to a window identifier of the first browser window.

14. An apparatus as defined in claim 13, wherein the browser history analyzer is to determine that the first browser window is a secondary browser window by determining that a time between the window open event and the window close event is less than a life span of a second browser window, the browser history analyzer to identify the second window based on one of the web page load events.

15. An apparatus as defined in claim 10, wherein the browser history analyzer is to identify the page load history by identifying a web page loaded in the first browser window between a browser window open event and a browser window close event for the first browser window.

16. An apparatus as defined in claim 15, wherein the browser history analyzer is to determine that the first browser window is a secondary browser window based on the page load history having one web page load.

17. An apparatus as defined in claim 10, wherein the browser history analyzer is to identify at least one of a second life span or a second page load history of a second browser window; and
the pop-up window identifier is to determine that the first browser window is a secondary browser window based on at least one of the second life span or the second page load history.

18. A computer readable storage medium comprising computer readable instructions which, when executed, cause a processor to at least:
identify a plurality of web page load events corresponding to a user action on a monitored device;
identify at least one of a life span or a page load history of a first browser window; and
determine that the first browser window is a secondary browser window based on at least one of the life span or the page load history.

19. A storage medium as defined in claim 18, wherein the instructions are to cause the processor to identify the plurality of web page load events by identifying at least two web page load events occurring between adjacent user actions.

20. A storage medium as defined in claim 18, wherein the instructions are to cause the processor to identify the plurality of web page load events corresponding to the user action by identifying the user action and the plurality of web page load events in an event log from the monitored device.

21. A storage medium as defined in claim 18, wherein the instructions are to cause the processor to identify the life span of the first browser window by identifying a window open event and a window close event corresponding to a window identifier of the first browser window.

22. A storage medium as defined in claim 21, wherein the instructions are to cause the processor to determine that the first browser window is a pop-up window by determining that a time between the window open event and the window close event is less than a life span of a second browser window, the second window being identified based on one of the plurality of web page load events.

23. A storage medium as defined in claim 18, wherein the instructions are to cause the processor to identify the page load history by identifying one or more web page loaded in the first browser window between a browser window open event and a browser window close event for the first browser window.

24. A storage medium as defined in claim 23, wherein the instructions are to cause the processor to determine that the first browser window is a secondary browser window based on the page load history having exactly one web page load.

25. A storage medium as defined in claim 18, wherein the instructions are further to cause the processor to:
identify at least one of a second life span or a second page load history of a second browser window; and
determine that the first browser window is a secondary browser window based on at least one of the second life span or the second page load history.

26. A storage medium as defined in claim 18, wherein the instructions are to cause the processor to determine that the first browser window is a secondary browser window by identifying, from the page load history, multiple web page load events occurring between a pair of user events.
